(19) United States
(12) Patent Application Publication
(10) Pub. No.: US 2006/0143930 A1
(43) Pub. Date: Jul. 6, 2006

(54) Hair dressing scissors

(76) Inventor: Hidemi Adachi, Seki-shi (JP)

Correspondence Address: Muramatsu & Associates, 114 Pacifica, Suite 310, Irvine, CA, 92618, US

(21) Appl. No.: 10/518,335

(22) PCT Filed: Mar. 24, 2004
(86) PCT No.: PCT/JP04/04105

§ 371 Date: Dec. 15, 2004

(51) Int. Cl. B26B 13/00

(52) U.S. Cl. 30/232

(57) ABSTRACT

It is to provide a pair of hairdressing scissors with finger grips that can accommodate the user even if his or her finger size, and his or her preference in structure and make of the finger grip, are different. In order to do so, each shear body of the haircutting scissors is at least composed of a shank and a finger grip, where the finger grip is removably attached to the shank. Further, different finger grips are prepared to be exchanged with one another.

### FIELD OF THE TECHNOLOGY

This invention relates to the improvement of hairdressing scissors, and more particularly, to hairdressing scissors which are capable of accommodating the hand and fingers of a user.

### BACKGROUND TECHNOLOGY

Hairdressing scissors are used by hairdressers. The size of the hands and fingers of the hairdressers vary from person to person.

On the other hand, there is no difference in the size of finger grips on the hairdressing scissors today, thus, hairdressing scissors with varying sizes of finger grips are not readily available. Since hairdressers have to hold a pair of hairdressing scissors all day long, the ease of use is heavily influenced by how well the finger grips fit the fingers. Particularly, each finger grip on a pair of hairdressing scissors is designed to fit only one finger (namely, unlike the finger grip of an ordinary pair of scissors where two fingers are inserted therethrough), and is comparatively small to closely fit the size of the finger. This is because the hairdressing scissors have to be held in a steady manner and controlled precisely to perform detailed maneuvers during the haircutting process. Therefore, each finger grip is made slightly bigger than the finger of the hairdresser so that there is only a limited space between the finger grip and finger.

Incidentally, there are hairdressing scissors with finger grips fitted with a rubber ring on the inside. Further, these rubber rings can be exchanged, where several rubber rings with varying diameters are prepared. In other words, the hairdresser can select a rubber ring that fits his or her finger and attach it to the inside of the finger grip to create a pair of custom fit scissors.

However, comparing to the typical stainless steel finger grip, the rubber ring will not slide smoothly and is not easy to use, thus, is not widely used.

Even if a finger grip is a general one without using a rubber ring, a user having large fingers have a hard time in inserting their fingers therethrough as well as using the hairdressing scissors due to the lack of space between the finger and finger grip since the finger grip is comparatively small as explained above. However, as mentioned above, there are no hairdressing scissors available that come with different finger grip sizes, thus, hairdressers have to use the scissors under such difficult conditions.

However, there arises a case where a user's finger is too large and hence, the finger grip on the hairdressing scissors is too small to use. In such a case, the finger grip is cut with a saw and widened to fit the finger.

This problem also applies to those with small fingers, where the finger grip of smaller size is needed. Further, other than the size of the finger grip, the shape and structure also play a role in affecting ease of use and preference of each hairdresser.

In view of the above problems, the object of the present invention is to provide hairdressing scissors which are capable of accommodating the hands and fingers of the user even if the size of the finger of the user or preference of the user regarding the shape and structure of the finger grips vary.

### DISCLOSURE OF THE INVENTION

In order to solve the above problems, the present invention relates to a shear body comprising a shank and a finger grip where the finger grip is removably attached to the shank. Thus, the finger grip is established separately from the shank where any method can be used for attaching and detaching the finger grip. Further, methods for attaching and detaching the finger grips to the two shear bodies can be the same or different from one another. Since the finger grip is detachable, by having finger grips with various sizes and shapes, each hairdresser can select a finger grip that matches his or her hand and finger, hence, making the hairdressing work easier.

In another embodiment of the present invention, the detachability of the finger grip is achieved by a screw. Namely, a first screw hole is established on the finger grip and a second is established on the shank. Under this arrangement, the finger grip is screwed into the second screw hole, thereby being detachably attached. The method for establishing the screw holes can be achieved in any manner, and this method can be the same or different for the two shear bodies.

Further, in another embodiment, a finger grip support is formed on the shank, where the finger grip to be attached to the shank will be supported by this finger grip support. Due to this configuration, a groove-like holder is established along the outer edge of the finger grip so that it can attach to the outer edge of the connecting portion of the shank. Further, on the shank, the finger grip support that supports this holder is extended from the end of the shank. Then, the finger grip support on the shank is received by the holder established on the finger grip to achieve detachability. Moreover, when the finger grip support is supported by the holder, the first and second screw holes are aligned so that the screw can be screwed therethrough. In this embodiment, the finger grip support of the shank supports the outer edge of the finger grip steadily without drift, which creates a feeling that the finger grip and the shank are one integral unit.

Further, in another embodiment, the holder of the finger grip is established on the outer side where the two finger grips face one another so that the pressure from the finger grip can be received by the finger grip support during the haircutting process, thereby enabling to avoid any rotational shift of the finger grip about the screw. Also, the force from the finger during the haircutting process is directly applied to the finger grip support, which makes the haircutting motion easier.

Further, in another embodiment, although the part where the finger grip support formed on the shank is the same, the holder on the finger grip is changed as follows. Namely, a step-like holder instead of a groove-like one is established on the outer edge so that the finger grip support on the shank can be held by this holder.

Further, in another embodiment, a first step formed on the finger grip and a second step formed on the shank are established so that they overlap with one another to form a connecting part between the finger grip and the shank. When the first and second steps overlap with one another, the first and second screw holes are aligned so that the screw can be screwed therethrough. In the method to establish the first and second steps, for example, the step can be formed on the shank, on the same side as the upper and lower sides of the shear body.

Further, in another embodiment, when the screw is screwed into the first screw hole established on the finger grip to attach the finger grip to the shank, the second screw hole is formed so that the screw can be screwed when it is aligned with the axis of the shank.

Further, in another embodiment, the screw works as the rotating axis so that a separate finger grip can be attached to the shank at a selected angle. According to this configuration, the direction of the finger grip can be changed at will so that it can be set at an angle according to how the scissors are held. On the contrary, the attached finger grip may rotate about the screw as the rotation axis. However, in such a case, a stopper for engaging the finger and shank to one another is established where the sides of the finger grip and shank overlap with one another when the screw is tightened. By doing so, the finger grip and the shank will not mutually shift by rotation when the screw works as the rotating axis.

### BRIEF DESCRIPTION OF THE DRAWINGS

FIG. 1 is a diagram showing a pair of hairdressing scissors of an embodiment 1A.

FIG. 2 is a diagram showing the situation where the finger grip is separated from the shank.

FIG. 3 is a diagram showing a pair of hairdressing scissors of an embodiment 1B.

FIG. 4 is a diagram showing the situation where the finger grip is separated from the shank.

FIG. 5 is a diagram showing a pair of hairdressing scissors of an embodiment 1C.

FIG. 6 is a diagram showing the situation where the finger grip is separated from the shank.

FIG. 7 is a diagram showing a pair of hairdressing scissors of the embodiment 2 where the finger grip is removed therefrom.

FIG. 8 is a cross sectional view taken along an A-A line.

FIG. 9 is a diagram showing a pair of hairdressing scissors of an embodiment 3.

FIG. 10 is a diagram showing the situation where the finger grip is separated from the shank.

FIG. 11 is a diagram showing a pair of hairdressing scissors of an embodiment 5 in which a portion where attaching the finger grip and the shank together is cut out.

FIG. 12 is a partially cut out diagram of the pair of hairdressing scissors.

FIG. 13 is a diagram showing a pair of hairdressing scissors of an embodiment 4.

FIG. 14 is a diagram showing the situation where the finger grip is separated from the shank.

FIG. 15 is a partially exploded view of the pair of hairdressing scissors of an embodiment 6.

FIG. 16 is a partially exploded view of the pair of hairdressing scissors of an embodiment 7.

### BEST MODE FOR IMPLEMENTING THE INVENTION

Next, the embodiments of the present invention will be explained.

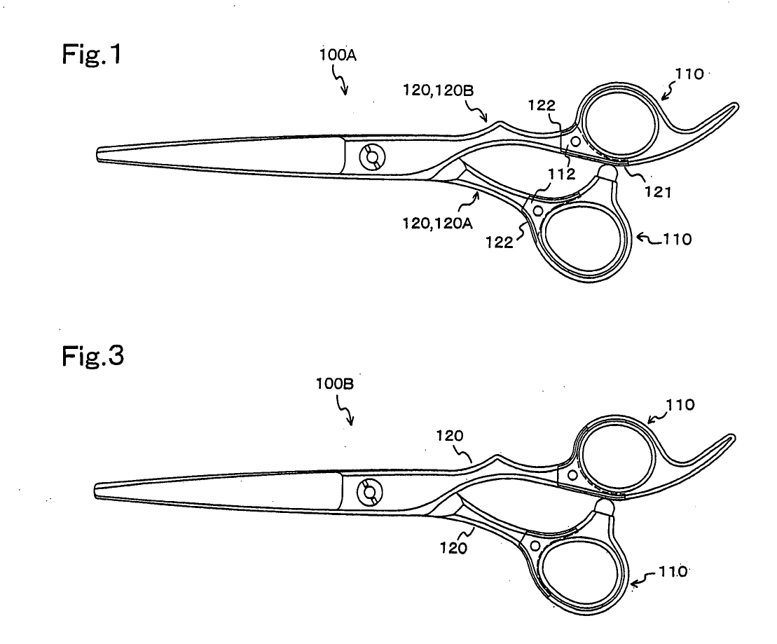

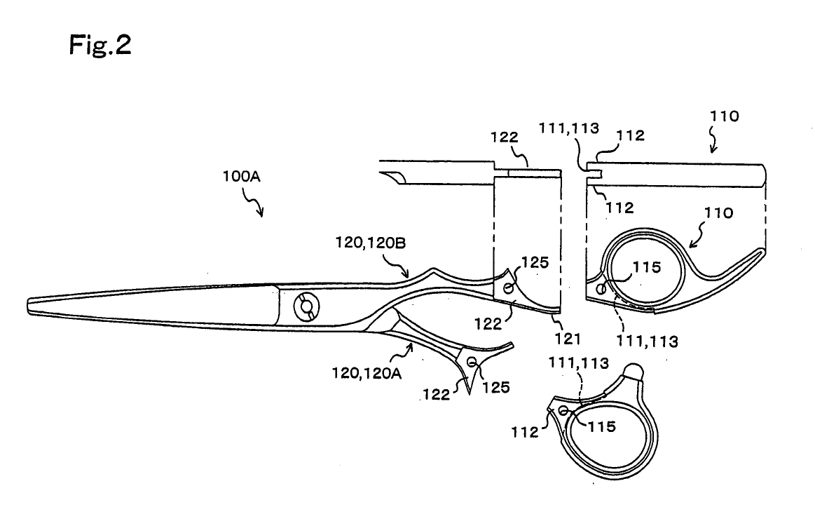

(Embodiment 1A) A pair of scissors 100 shown in FIG. 1 is an embodiment directed to claim 4 where a groove-like holder 111 formed on an outer edge of a finger grip 110 as shown in FIG. 2 is extended to fit along an outer edge of the connecting part of a shank 120. Further, on the shank 120, a finger grip support 121 that will be held by the holder 111 is formed in a manner that it extends from an end portion 122 of the shank 120. There are two finger grips 110 on a pair of scissors, however, the shape as well as the location of each finger grip 110 will vary depending on which shank 120 the finger grip will be attached to. On the shank 120A of a moving blade, the finger grip support is comparatively formed in the Y-letter shape, and on the shank 120B of the stationary blade, the finger grip support 121 is formed in a manner to extend toward one side.

More specifically, the finger grip 110 includes two connecting pieces 112 on upper and lower sides which protrude from the outer edge to connect with the shank 120, where a slit 113 is formed between the two connecting pieces. Then, the slit 113 is joined with a groove 114, i.e., the slit 13 and the groove 14 form the holder 111.

The end portion 122 of the shank 120 is formed thinner so that it can be inserted into the slit 113 on the finger grip 110. The end portion 122 is extended along the outer edge of the finger grip 110 thereby forming the finger grip support 121.

On the finger grip 110, a first screw hole 115 is established which extends through both of the connecting pieces 112, and on the thin end portion 122 on the shank 120, a second screw hole 125 is established. Further, the two screw holes 115 and 125 are aligned so that they can be screwed together when the finger grip support 121 is held by the holder 111. Then, by screwing them together, the scissors become like the one shown in FIG. 1.

According to this configuration, when closing the scissors, the force applied by the finger is received by the finger grip support 121 on the shank, which improves the feeling on the finger. Further, since the majority of the finger grip support 121 is supported by the holder 111, the finger grip 110 will not drift relative to the shank 120, which gives a feeling that the shank 120 and the finger grip 110 are one integral unit during the opening and closing movements of the scissors. Further, the finger grip support 121 will not easily be exposed since it is held by the finger grip 110, which promotes the feeling that the shank 120 and the finger grip 110 are one integral unit as well as improves the outer appearance.

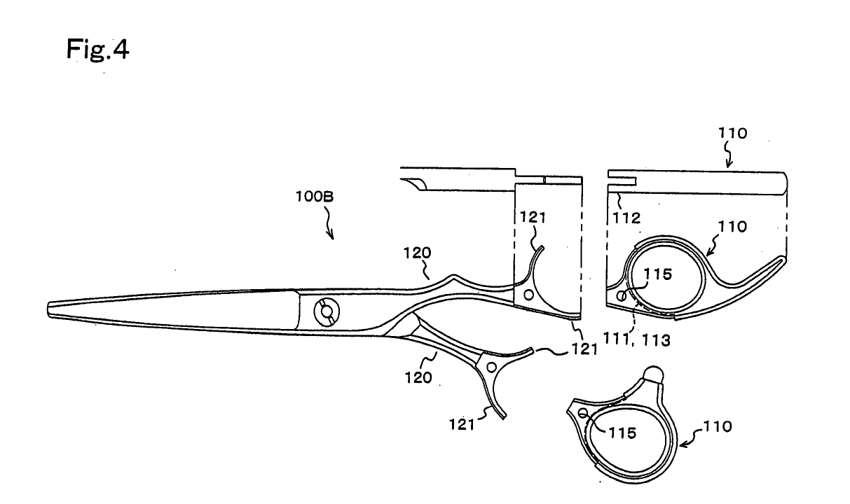

(Embodiment 1B) The pair of scissors 100B shown in FIGS. 3-4 is similar to the pair of scissors 100A of the embodiment 1A, however, the finger grip support 121 on the shank 120 is made longer and is in the Y-letter shape. With this structure, the support on the finger grip 110 is strengthened, resulting in a more stable finger grip 110.

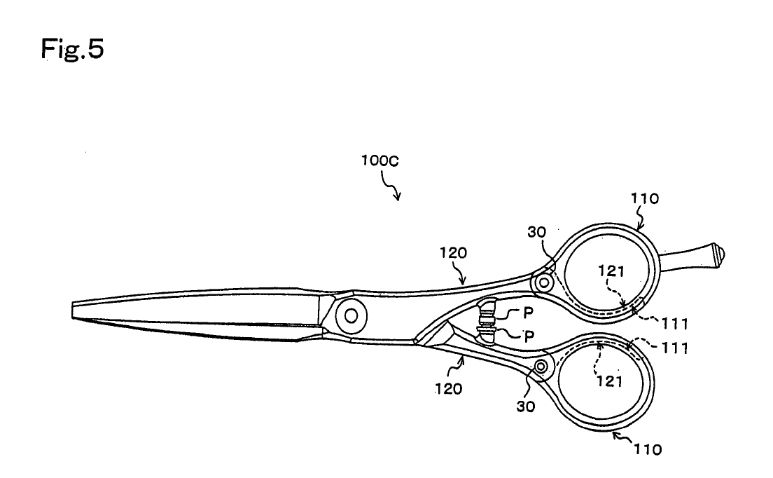

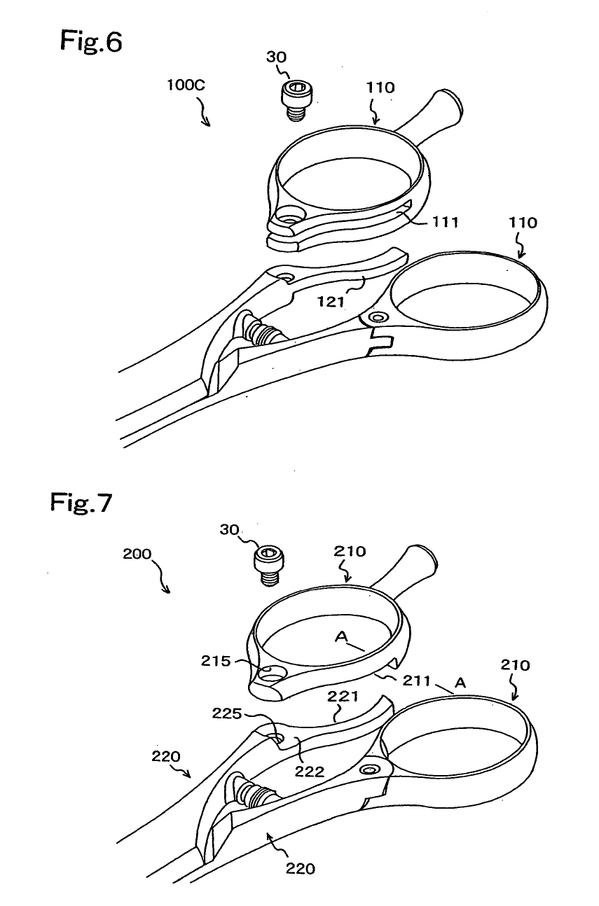

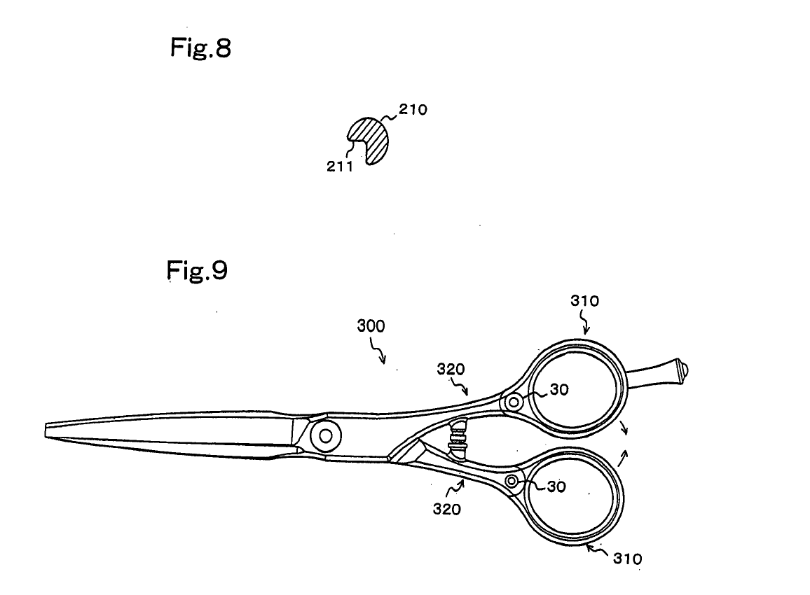

(Embodiment 1C) In the pair of scissors 100C shown in FIG. 5-6, the finger grip support 121 is established only on the sides where the finger grips 110 and 110 face each other. Since the force exerted to the finger grip 110 when closing the scissors is received by the finger grip support 121 held by the holder 111, it give the feeling that the finger grip 110 and shank 120 are one integral unit and the hand can feel comfortable when using the scissors. The closing position of the pair of scissors 100C is determined by a hit point P. The hit point P is generally established on the finger grip. However, in this pair of scissors 100C, a hit point P and a hit point receiver P′ are established on the shank 120, thus, the closing position is not affected by the replacement of a finger grip 110 as well as the change of a space between the two finger grips 110 and 110 caused by the replacement.

(Embodiment 2) The pair of scissors 200 shown in FIG. 7 is an embodiment directed to claims 6-7, where the outer edge of each of the finger grips 210 and 210 that face one another is formed with a step-like indentation, which creates a holder 211 for holding a finger grip support 221 that will be explained later. The holder 211 is established from a connection point along the shank 220. An end portion 222 of the shank 220 is extended to form a finger grip support 221 to be held by the holder 211. The holder 211 and the finger grip support 221 of the scissors 200 are established only on the side where the finger grips 210 and 210 face one another. In this configuration as well, when the scissors 200 are closed, the force exerted to the finger grip 210 is received by the finger grip support 221, so when in use, it gives a feeling that the finger grip 210 and the shank 220 are one integral unit, thereby improving the feeling on the hand during the operation.

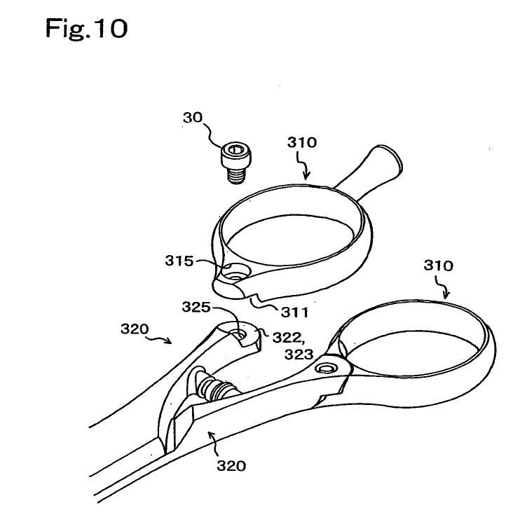

(Embodiment 3) The pair of scissors 300 shown in FIGS. 9-10 is an embodiment directed to claim 8, where the connecting part for a finger grip 310 and a shank 320 is formed with a first indentation 311, and an end portion 322 of the shank 320 is formed with a second indentation 323 corresponding to the shape of the first indentation 311. When the two indentations 311 and 323 are overlapped with one another, a first screw hole 315 and a second screw hole 325 line up in a direction perpendicular to a surface of the finger grip 310 for screwing.

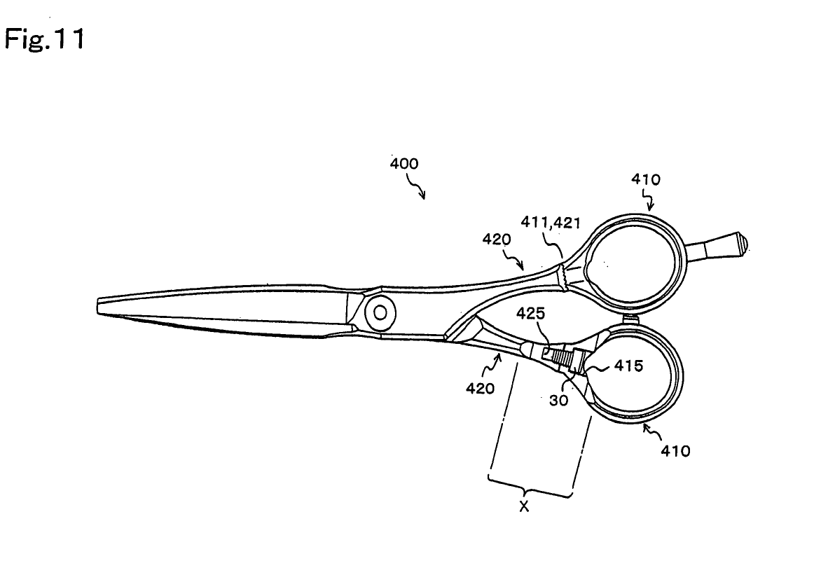

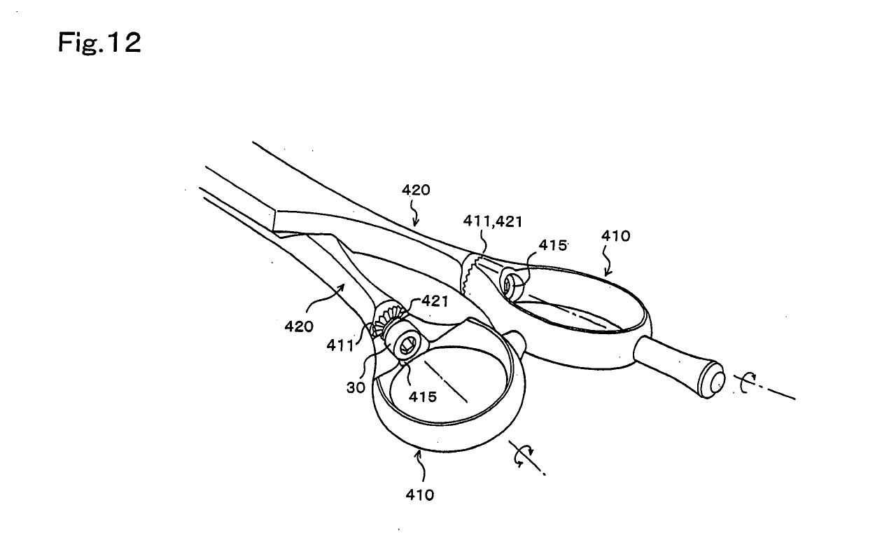

(Embodiment 4) The pair of scissors 400 shown in FIGS. 11-12 is an embodiment directed to claims 9-11, where, as shown by the cut out portion X in FIG. 11, a first screw hole 415 is established from the inside to the outside of a finger grip 410 in a direction along an axis of a shank 420 when the finger grip 410 is attached. Further, a second screw hole 425 is formed on the shank 420 where it lines up with the first screw hole 415. Then, a screw 30 is screwed from the inside of the finger grip 410 to tighten the first screw hole 415 and the second screw hole 425 together. Moreover, the finger grip 410 can rotate relative to the shank 420 about the screw 30 as the rotating axis so that the angle relationship between the shank 420 and the finger grip 410 can be adjusted. Further, stepped surfaces where a first overlapping surface 411 on the finger grip 410 and a second overlapping surface 421 on the shank 420 engage with one another are formed to work as a stopper. When the angle relationship of the finger grip 410 relative to the shank 420 is selected and tightened with the screw, an angle shift as shown by the arrow in FIG. 12 will not arise because of the stopper.

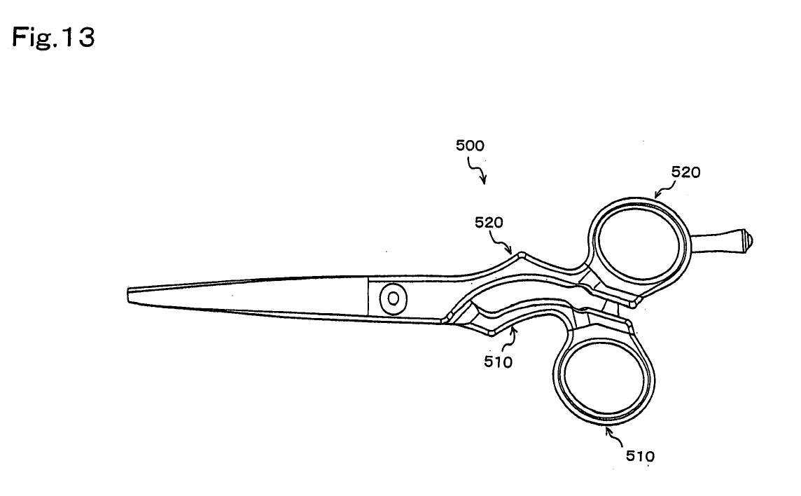

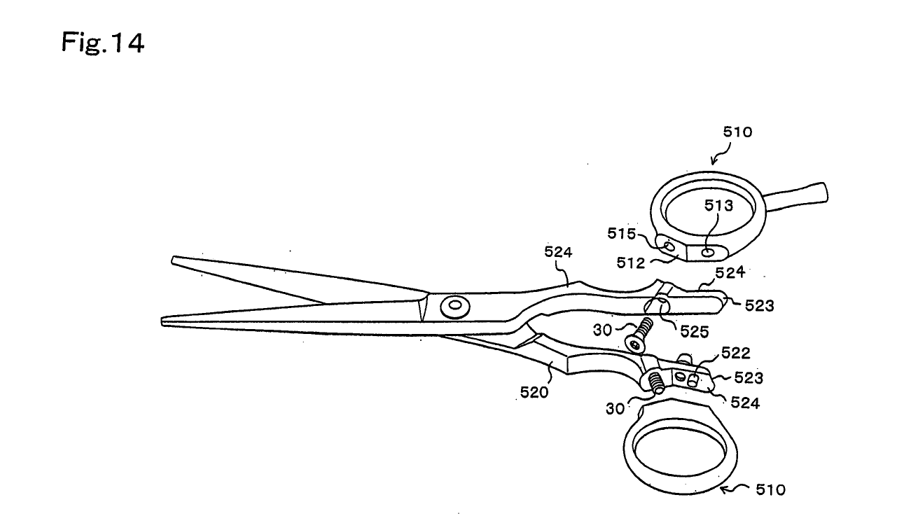

(Embodiment 5) The pair of scissors 500 shown in FIG. 13 is structured so that a finger grip 510 can be removed from a shank 520 in a manner shown in FIG. 14. In other words, this pair of scissors 500 includes a first screw hole 515 established on the finger grip 510, a second screw hole 525 established on the shank for attaching to the finger grip 510, and a screw 30 for screwing the first screw hole 515 and the second screw hole 525 together. The details are described as follows.

The outer surface of the finger grip 510 is formed with a first connecting surface 512, which works as a connecting surface when the shank 520 is attached. Further, on the first connecting surface 512, a first screw hole 515 and a stopper hole 513 for engaging with a projection 522 formed on the shank as will be described later are established.

The shank 520 is formed to have a shape so that end portions 523 and 523 are parallel with one another. An outer side of the end portion 523 will be attached with the finger grip 510, and at this location, a second connecting surface 524 that corresponds with a first connecting surface 512 on the finger grip 510 is formed. Further, a second screw hole 525 is formed therethrough, and a small column like projection 522 is established on the second connecting surface 524 so that it will fit into a stopper hole 513 on the finger grip 510.

In regards to the attachment of the finger grip 510, first, the finger grip 510 is fit with the projection 522 of the shank 520, then, a screw 30 is inserted from an inner side of the shank 520 (the side where the two shanks 520 and 520 face one another), where it is screwed through the shank 520 until it reaches the finger grip 510. When removing the finger grip 510, this process is reversed.

By this structure and method, the exchange of finger grips 510 can be made possible. Therefore, by having several types of finger grips with different sizes and shapes prepared in advance, the user can obtain a pair of scissors with the finger grips that accommodate the size of his or her fingers and his or her preference.

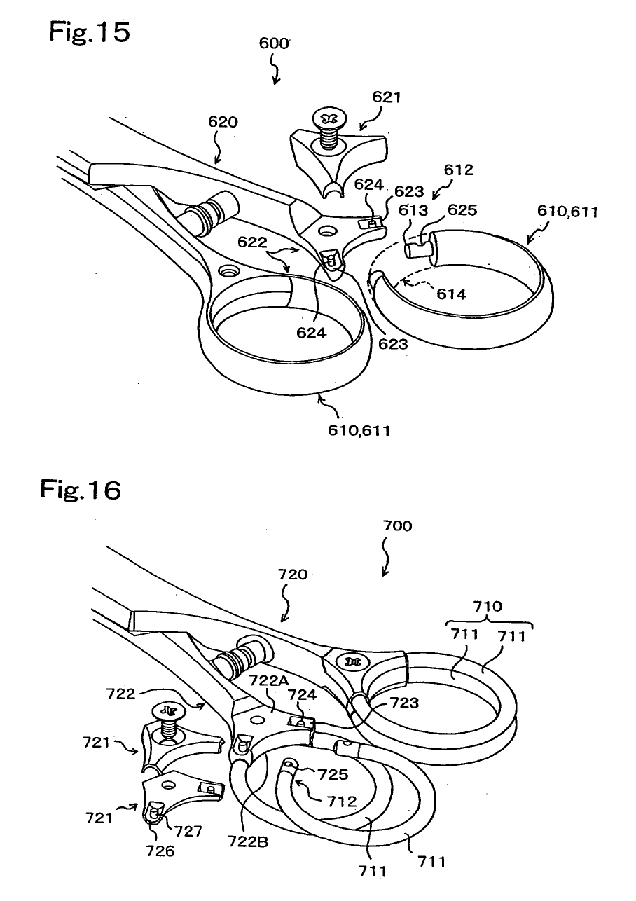

(Embodiment 6) In the pair of scissors 600 shown in FIG. 15, an exchangeable finger grip 610 is formed as a ring 611 where a portion of the ring is cut out. Ends 612 of the cut out portion are held by a push cover 621 that is attached to the shank 620 through a screw. Namely, a thin projection 613 is established on each end 612 of the cut out portion of the finger grip 610. Further, an end portion 622 of the shank is formed in the Y-letter shape, and this Y-letter shaped portion compensates for an absent portion 614 on the finger grip 610. Further, the end portion 622 with the Y-letter shape is cut out at an upper half as shown in FIG. 15, where the remaining lower half portion of the end portion 622 is formed with an indentation 623 for receiving the projection 613 of the finger grip 610. Then, the projection 613 of the finger grip 610 is fitted into the indentation 623. Further, a pin 624 is established on the indentation 623, which fits with a stopper hole 625 formed on the projection 613. Then, after fitting the finger grip 610 in a holder 26 of the shank 620, the push cover 621 is placed thereon and tightened by a screw to complete the attachment process.

(Embodiment 7) In the pair of scissors 700 shown in FIG. 16, a finger grip 710 that can be exchanged in the same way as in the embodiment 6 includes two finger grips 711 and 711 each having a cut out portion overlapping with one another, where the attachment method is also the same as in the embodiment 6.

Namely, an end portion 722 of a shank 720 is formed in the shape of letter Y, and an upper side and a lower side of the Y-letter shaped end portion 722 are cut out. Then, on the upper side 722A and the lower side 722B of the cut out Y-letter shaped end portion 722, indentations 723 are formed for fitting with ends 712 of the rings 711. Further, the rings 711 fitted into the indentations 723 are fixed by being sandwiched by two push covers 721 and 721 from the upper and lower sides.

Further, a pin 724 is established in the indentation 723 of the upper side so that it will fit into a stopper hole 725 formed through the end 712 on the upper ring 711. On the other hand, there is no pin in the indentation of the lower side, where instead, a pin 727 is established in an indentation 726 of the bottom push cover so that the stopper hole formed through the end of lower ring 711 will fit with the pin.

Then, the two rings 711 and 711 are fitted into the indentations 723 on the upper and lower sides, where they are covered by two push covers 721 and 721 and tightened with a screw to complete the attachment process.

Therefore, the scissors in the foregoing have several kinds of exchangeable finger grips prepared in advance, and since various sizes and shapes of the finger grips are available, a pair of scissors attached with a preferable size and shape can be achieved.

What is claimed is:

1. Hairdressing scissors having two shear bodies attached to one another, characterized in that said shear body is comprised of a shank and a finger grip where said finger grip is removably attached to the shank.

2. Hairdressing scissors as defined in claim 1, wherein different finger grips are prepared to be exchanged with one another.

3. Hairdressing scissors as defined in either claim 1 or claim 2, further comprising a first screw hole established on the finger grip and a second screw hole established on the shank, wherein said finger grip is removably attached by screwing said finger grip to said second screw hole.

4. Hairdressing scissors as defined in claim 3, further comprising a groove-like holder formed on an outer edge of the finger grip from a connecting part of the shank along the outer edge, and a finger grip support formed on said shank in a manner extended from an end portion of said shank for fitting into said holder, wherein the first and second screw holes are aligned so that the first and second screw holes can be screwed together when said finger grip support is held by said holder.

5. Hairdressing scissors as defined in claim 3, wherein the holder and the finger grip support to be held by the holder are established on an outer side where the two finger grips face one another.

6. Hairdressing scissors as defined in claim 3, further comprising a step-like holder formed on one outer edge of the finger grip from a connecting part of the shank along the outer edge, and a finger grip support formed on said shank in a manner extended therefrom for fitting into said holder, wherein the first and second screw holes are aligned so that they can be screwed together when said finger grip support is held by said holder.

7. Hairdressing scissors as defined in claim 3, wherein the holder and the finger grip support to be held by the holder are established on an outer side where the two finger grips face one another.

8. Hairdressing scissors as defined in claim 3, further comprising a first indentation formed on the finger grip and a second indentation formed on the shank, wherein the first and second indentations are shaped to overlap with one another for establishing a connecting part, and wherein when said first indentation and said second indentation are overlapped, the first screw hole and the second screw hole are aligned so that they can be screwed together.

9. Hairdressing scissors as defined in claim 3, wherein the second screw hole is formed so that the screw is tightened along an axis of the shank when said screw is inserted through the first screw hole established on the finger grip for attaching said finger grip to the shank.

10. Hairdressing scissors as defined in claim 3, wherein an angle relationship between the shank and the finger grip using the screw as a rotational axis can be selectable when being attached.

11. Hairdressing scissors as defined in claim 10, further comprising a stopper formed on overlapping surfaces of the finger grip and the shank when tightening the screw, wherein an angle shift between the finger grip and the shank about the screw as the rotational axis is eliminated.
